(19) United States
(12) Patent Application Publication
(10) Pub. No.: US 2016/0033071 A1
(43) Pub. Date: Feb. 4, 2016

(54) SHUTTER WITH AUTOMATICALLY EXPANDING SEALING RING

(71) Applicant: RAVETTI S.R.L., Frassineto Po (AL) (IT)

(72) Inventor: Roberto RAVETTI, Frassineto Po (IT)

(73) Assignee: RAVETTI .S.R.L., Frassineto Po (IT)

(21) Appl. No.: 14/775,755

(22) PCT Filed: Feb. 24, 2014
(86) PCT No.: PCT/IT2014/000049

§ 371 Date: Sep. 14, 2015

(30) Foreign Application Priority Data
Mar. 16, 2013 (IT) TO2013A000205

(51) Int. Cl. F16L 55/124

(52) U.S. Cl. CPC F16L 55/124

(57) ABSTRACT

A shutter (1) with automatically expanding sealing ring is described, adapted to close a duct (1′) and mobile along a vertical axis perpendicular to the longitudinal axis of the duct (1′), comprising: an abutment block (1A) adapted to support the pressure inside the duct (1′); and a head (IB) adapted to make the seal to the pressure inside the duct (1′), the head (IB) assuming a rest position outside the duct (1′) wherein it is coaxial with the abutment block (1A) along the vertical axis, and an operating sealing position inside the duct (1′) along the longitudinal axis of the duct (1′). The head (IB) being equipped with particular mobile sectors (10) which automatically go out during their insertion operation in order to contain and protect the sealing ring (7) of the head (1B).

The present invention relates to a shutter with automatically expanding sealing ring.

Within the transport and distribution of fluids, the function of a shutter is allowing the closure of a duct so that, if two shutters are used, it is possible to section the length intercepted by them, guaranteeing the delivery of a service to users by employing a by-pass.

The shutter with automatically expanding sealing ring has been developed to guarantee the seal inside ducts in which the pressure reaches high values, of the order of 80 bar and more.

This does not prevent such type of shutter from being used also in ducts for which the main problem to be solved is not the high pressure, but the variability of the internal diameter with the same rated diameter.

Currently marketed systems use, for the transmission of forces, a complex kinematic chain (composed for example of bevel gear pairs, universal joints, transmission rods, etc.) or even an hydraulic circuit, therefore complex and potentially unreliable solutions.

Document EP-A-2 378 179 discloses a shutter according to the preamble of claim 1.

Therefore, object of the present invention is solving the above prior art problems, by providing a shutter with automatically expanding sealing ring which has as features its suitability and its easiness with respect to prior shutters.

The above and other objects ad advantages of the invention, as will appear from the following description, are obtained with a shutter with automatically expanding sealing ring as claimed in claim 1. Preferred embodiments and non trivial variations of the present invention are the subject matter of the dependent claims.

It is intended that all enclosed claims are an integral part of the present description.

The present invention will be described below through some non-limiting embodiments thereof, with reference to the enclosed drawings, in which:

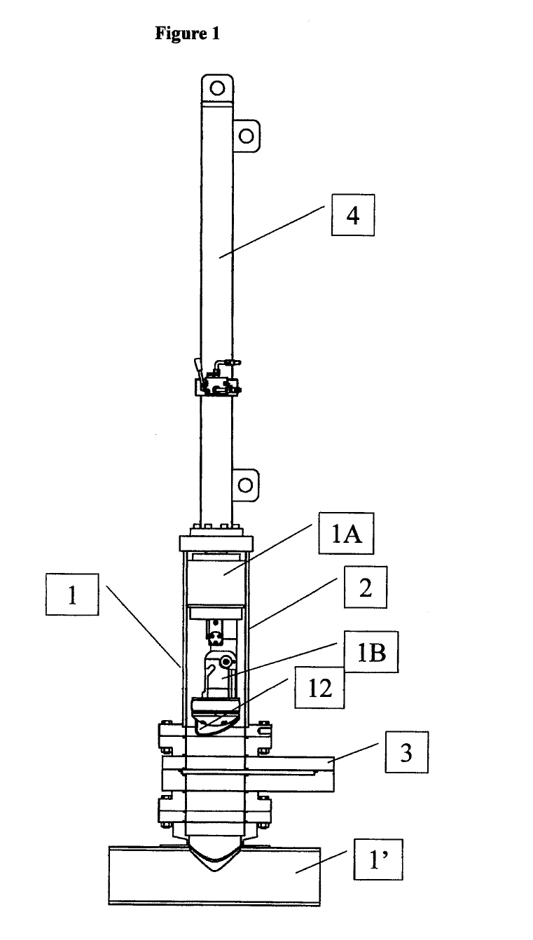

FIG. 1 shows a side schematic view of an embodiment of the shutter of the present invention in its rest position, namely when the duct is not closed;

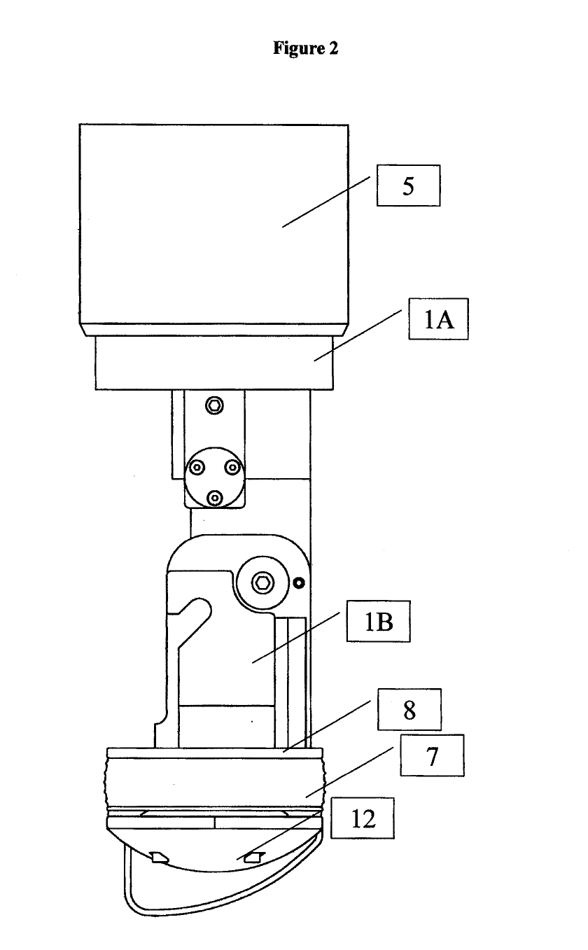

FIG. 2 shows a detailed view of the shutter of FIG. 1;

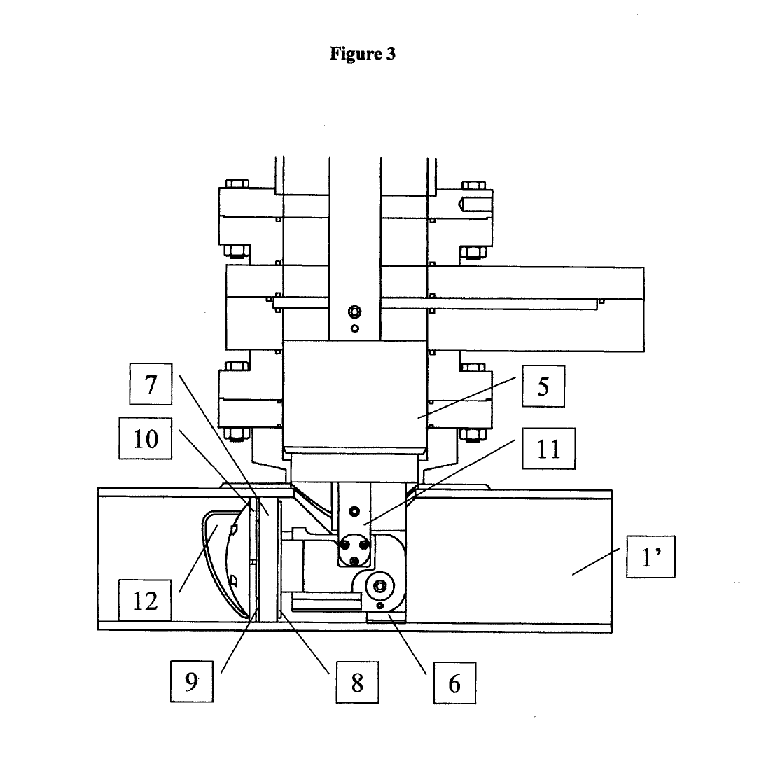

FIG. 3 shows a detailed view of the shutter of FIG. 1 in its operating position when closing the duct;

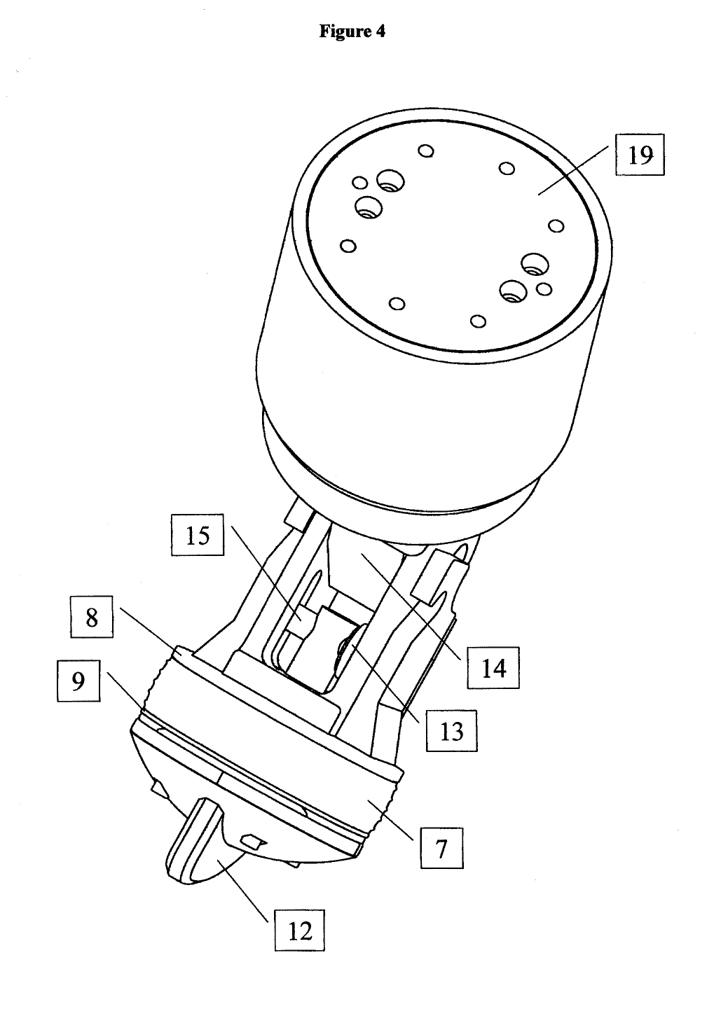

FIG. 4 shows a top perspective view of the shutter of FIG. 1; and

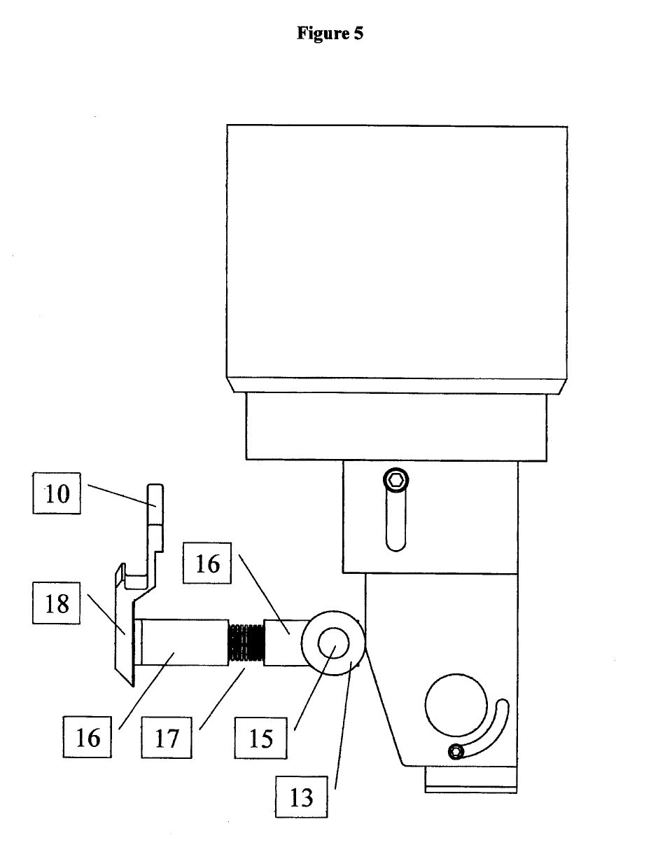

FIG. 5 shows a schematic view of the internal operating parts of the shutter of FIG. 1.

With reference to the Figures, some preferred embodiments of the present invention are shown and described. It is clear for a skilled person in the art that numerous modifications and variations (for example related to shake, sizes, arrangements of parts and equivalent technical solutions) can be made to the present invention, without departing from its scope, as appears in the enclosed claims.

With reference to FIG. 1, the shutter with automatically expanding sealing ring 1 of the present invention, when it is outside the duct 1′, is housed inside a bell 2 fastened through flanged connection to a plate valve 3, which makes the entry opening to the duct 1′.

The bell 2 can be equipped with a mouth (not shown) adapted to make a possible embedded by-pass.

The shutter 1 moves along the vertical axis due to an hydraulic cylinder 4 supplied by an oil-dynamic unit (not shown).

Another possible variation provides that movements are obtained through a manually actuated mechanical device (not shown), such as for example a screw.

With reference to FIGS. 2 and 3, the operating principle of the inventive shutter 1 is shown.

The shutter 1 is essentially composed of two parts, constrained one to the other by an hinge. They have the following denominations and functions.
1) Abutment block 1A: its task is supporting the pressure operating inside the duct 1′. In fact, it discharges the pressing force in two ways:
   through the lateral surface 5 on the channel with constant diameter formed by the passage inside a shaped fitting and of the plate valve 3
   through the abutment 6 on the bottom of the duct 1′.

The abutment, composed of a small interchangeable block, allows adapting to different internal diameters for each rated diameter of the duct 1′.
2) Head IB of the shutter 1: it is the parte responsible for making the pressure seal. This occurs through the compression of a sealing ring 7 with trapezoidal section compressed by a mobile flange 8 against a fixed flange 9.

In order to contain the sealing ring 7 (which otherwise, under the thrust of the pressure, would be removed from its seat) and to protect it from possible damages deriving from cutting and welding operations downstream of the shutter 1, the head IB is equipped with mobile sectors 10 that automatically go out during the insertion operation.

With reference to FIGS. 3 to 5, the kinematics of the shutter 1 is as follows.

During the first inserting step, the head 1B of the shutter 1 is aligned with the abutment block 1A along the vertical axis.

When the chute 12 placed at the lower end of the head 1B touches the bottom of the duct 1′, the head 1B starts rotating till its axis is the same as the duct 1′ and at 90° with respect to the abutment block 1A.

In such position, the small interchangeable block fastened to the abutment block 1A is resting on the bottom of the duct 1′.

The sectors 10 go out of their seat due to the contact of the wheels 13 on the convex surface 14.

Such wheels 13 push, through the axle 15, the assembly composed of two cylinders 16 between which a pack of belleville washers 17 is interposed.

The assembly pushes in turn the frustum-of-cone 18 which, through its lateral surface, transfers the compressing force to the mobile sectors 10 which thereby go out.

The connection between assembly and sectors 10 can also occur with different systems, employing cams or slots, inside which pins integral with the sectors 10 slide.

If the internal diameter of the duct 1′ is smaller than the diameter of the circumference intercepted by the sectors 10 in its maximum expansion position, the compressing force is discharged onto the pack of belleville washers 17, compressing them.

Now, stroke of the hydraulic cylinder 4 goes on, getting to compress the block 19.

It is housed inside the abutment block 1A and suspended through a spring (not shown).

Its function is allowing to transfer the force generated by the hydraulic cylinder 4 to the abutment block 1A and then to the head 1B of the shutter 1, to make its rotation and make the sectors 10 go out.

When the head 1B of the shutter 1 is in its operating position inside the duct 1′, the block overcomes the force of the spring and starts going downwards: the brackets 11 constrained thereto then transmit the vertical force to the mobile flange 8 which, by horizontally translating, gets to compress the sealing ring 7.

1. Shutter with automatically expanding sealing ring adapted to close a duct and mobile along a vertical axis and substantially perpendicular to the longitudinal axis of the duct, comprising:
at least one abutment block adapted to support the pressure inside; and
at least one head adapted to make a seal to a pressure inside duct, said head assuming a rest position outside the duct wherein it is coaxial with the abutment block along a vertical axis, and an operating sealing position inside the duct along a longitudinal axis of the duct;
wherein the head makes the pressure seal through a compression of a sealing ring with trapezoidal section compressed by a mobile flange against a fixed flange the head being equipped with mobile sectors which automatically go out during their insertion operation in order to contain and protect the sealing ring,
wherein, starting from a rest position in which the head is aligned with the abutment block along the vertical axis, to get to its sealing position in the duct, when a chute placed at the lower end of the head touches the bottom of the duct, the head is adapted to start rotating till it gets coaxial with the duct and substantially at 90° with respect to the abutment block, in such position, the small interchangeable block fastened to the abutment block being resting on the bottom of the duct, the sectors going out of their seat due to the contact of wheels onto the convex surface of the abutment block, such wheels being adapted to push, through an axle, an assembly composed of two cylinders between which a pack of belleville washers is interposed, the assembly pushing in turn a frustum-of-cone which, through its lateral surface, transfers the compressing force to the mobile sectors which thereby go out, if the internal diameter of the duct is smaller than the diameter of the circumference intercepted by the sectors in a maximum expansion position, the compressing force being discharged onto the pack of belleville washers, compressing them.

2. Shutter according to claim 1, wherein, when it is out of the duct it is housed inside a bell fastened through a flanged connection to a plate valve, which performs the entry opening to the duct.

3. Shutter according to claim 2, wherein the bell is equipped with a mouth adapted to make an embedded by-pass.

4. Shutter according to claim 1, wherein it is adapted to move along the vertical axis though an hydraulic cylinder supplied by an oil-dynamic unit or through a manually actuated mechanical device, for example a screw.

5. Shutter according to claim 1, wherein said two parts are mutually constrained by an hinge.

6. Shutter according to claim 1, wherein the abutment block is adapted to discharge the pressing force against a lateral surface on a channel with constant diameter composed of a passage inside a shaped fitting and of the plate valve and through an abutment on the bottom of the duct, the abutment, composed of a small interchangeable block, allowing to adapt to different internal diameters for each rated diameter of the duct.

7. Shutter according to claim 1, wherein a connection between assembly and sectors alternatively occurs using cams and slots, inside which pins integral with the sectors slide.

8. Shutter according to claim 1, wherein, the stroke of the hydraulic cylinder goes on, getting to compress a block of the abutment block, the block being housed inside the abutment block and being suspended through a spring, function of the spring being to allow the transfer of the force generated by the hydraulic cylinder to the abutment block and then to the head, to make its rotation and make the sectors go out, while when the head is in its operating position inside the duct, the block overcomes the force of the spring and starts going downwards, the brackets constrained thereto transmitting the vertical force to the mobile flange which, by horizontally translating, gets to compress the sealing ring.
